(19) United States
(12) Patent Application Publication
(10) Pub. No.: US 2011/0043708 A1
(43) Pub. Date: Feb. 24, 2011

(54) OPTIMIZED MOBILE TELEVISION

(75) Inventors: James Clardy, Austin, TX (US); Shree A. Dandekar, Round Rock, TX (US); Subramanian Jayaram, Austin, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/544,768

(22) Filed: Aug. 20, 2009

(51) Int. Cl. H04N 5/50

(52) U.S. Cl. 348/731

(57) ABSTRACT

A television (TV) receiver system includes a circuit having a TV tuner. The tuner receives a terrestrial TV broadcast and a mobile TV broadcast. A motion detection system is coupled to the tuner. The motion detection system detects a motion status of the tuner. A broadcast detection system is coupled to the tuner. The broadcast detection system identifies a source of one of the terrestrial TV broadcast and the mobile TV broadcast. A tuner switching system is coupled to the tuner. The tuner switching system causes the tuner, as a function of the motion status, to automatically select one of the terrestrial TV broadcast and the mobile TV broadcast for processing and displaying.

### BACKGROUND

The present disclosure relates generally to information handling systems, and more particularly to optimized mobile television using an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

For example, a user may be able to watch broadcast television (TV) programs or other content on a mobile consumer electronic (CE) device such as a mobile telephone, a portable IHS, etc., using a single frequency television data broadcast network. Examples of such broadcast networks include Advanced Television Systems Committee—Mobile/Handheld (ATSC—M/H), Digital Video Broadcasting—handheld (DVB-H) networks, China Multimedia Mobile Broadcasting (CMMB) networks and a variety of other networks. These single frequency television data broadcast networks are typically optimized for use with mobile devices. Mobile devices, however, generally include smaller displays, lower quality sound systems and the like, when compared to household or commercial devices for use receiving broadcast television signals. As such, these mobile networks typically broadcast their TV broadcast signals using lower resolution video, lower sound quality and the like.

On the other hand, multi-frequency broadcast networks, such as Digital Video Broadcasting—Terrestrial (DVB-T), have a broadcasting signal that has been optimized for video quality. Optimizing these broadcasts for video quality for household or commercial devices comes at the expense of mobility support.

Unfortunately, a user has not been able to move seamlessly from a fixed-location DVB-T type TV broadcast to a more mobile, on-the-go DVB-H type broadcast or vice versa using a single reception device. In other words, there has not been a way to automatically transfer between a single frequency to a multi-frequency network and vice versa to optimize broadcast reception to a better frequency network, whether stationary or mobile. As such, this can be an inconvenience for users who want to optimize their battery life, move from a stationary location to a mobile setting (e.g., in a taxi, train, etc.) or simply watch a higher quality video broadcast when they are stationary and/or plugged into an AC source.

Accordingly, it would be desirable to provide an improved optimized mobile television system.

### SUMMARY

According to one embodiment, a television (TV) receiver system includes a circuit having a TV tuner. The tuner receives a terrestrial TV broadcast and a mobile TV broadcast. A motion detection system is coupled to the tuner. The motion detection system detects a motion status of the tuner. A broadcast detection system is coupled to the tuner. The broadcast detection system identifies a source of one of the terrestrial TV broadcast and the mobile TV broadcast. A tuner switching system is coupled to the tuner. The tuner switching system causes the tuner, as a function of the motion status, to automatically select one of the terrestrial TV broadcast and the mobile TV broadcast for processing and displaying.

### BRIEF DESCRIPTION OF THE DRAWINGS

FIG. 1 illustrates an embodiment of an information handling system (IHS).

FIG. 2 illustrates a block diagram of an embodiment of a television tuner system for optimized mobile television.

FIG. 3 illustrates a block diagram of an embodiment of an IHS having an optimized mobile television system.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

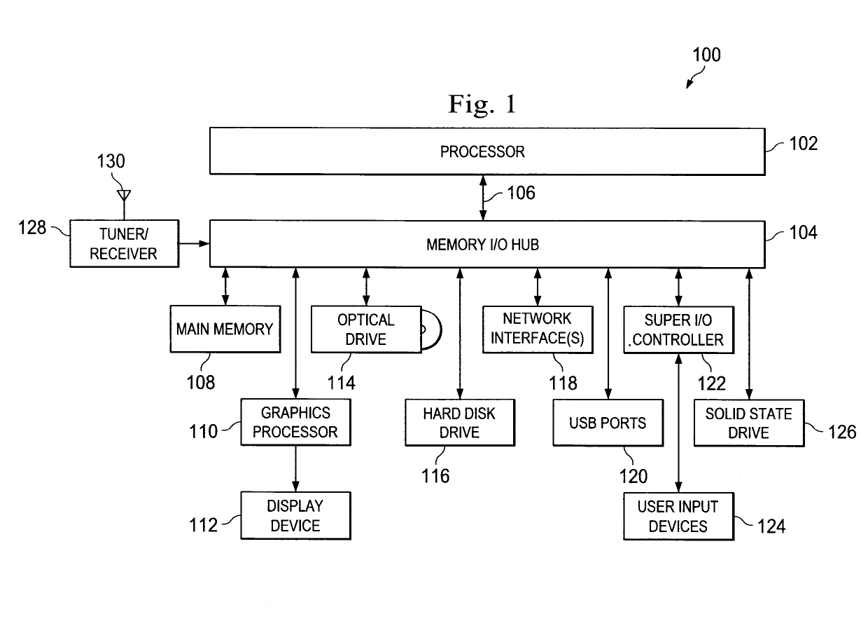

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

An embodiment of the IHS 100 includes a television (TV) tuner/receiver 128 system. As will be described in more detail below, the TV tuner 128 may automatically optimize mobile TV reception depending on whether the tuner 128 and/or the IHS 100 is stationary or in motion. To receive TV broadcast signals, the tuner 128 includes an antenna 130. The antenna 130 may be enclosed within the IHS 100 and out of view, may be at least partially external to the IHS 100 and in view or may be incorporated into a frame or shell of the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

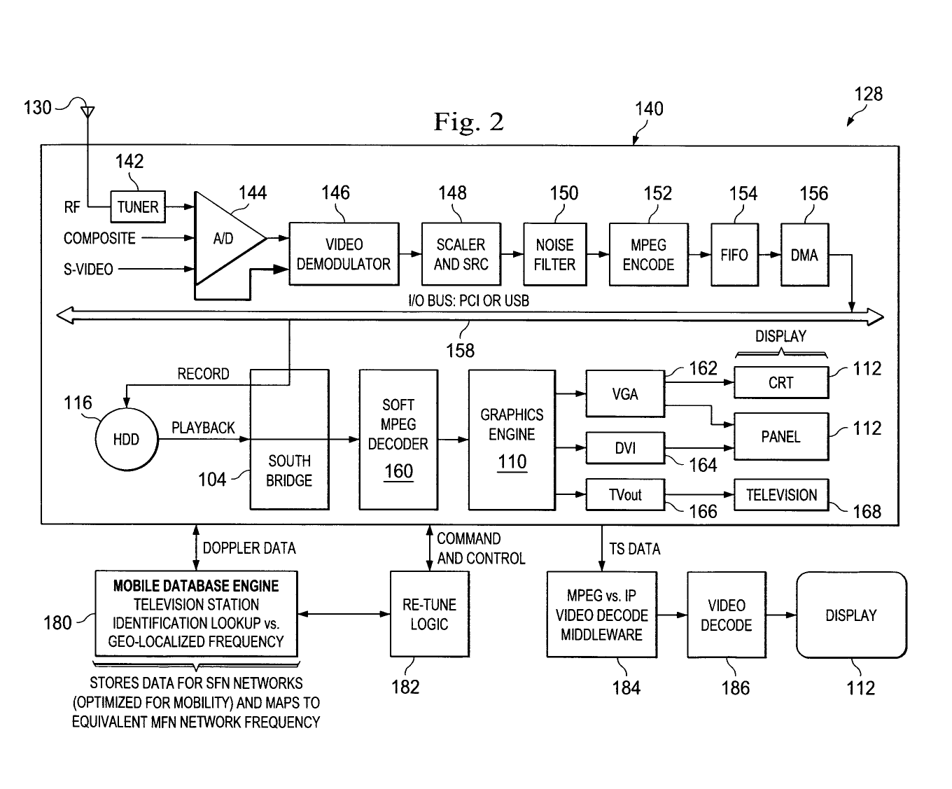

FIG. 2 illustrates a block diagram of an embodiment of a television tuner system 128 for optimized mobile television. In an embodiment, the tuner system 128 includes a TV tuner signal path system 140, as used on an IHS 100 for viewing TV broadcasts on the IHS 100. In addition, the tuner system 128 of the present disclosure includes mobile optimization systems (described below) incorporated with or coupled to the TV tuner signal path 140. The TV tuner signal path system may be similar to that used on other IHSs for TV broadcast viewing.

The signal path system 140 may receive a TV broadcast signal from any TV broadcasting system. For example, the TV broadcast signal may be received as a radio frequency (RF) signal via an antenna 130 by a standard TV tuner 142. In another example, the TV broadcast signal may be received as a composite video signal. In yet another example, the TV broadcast signal may be received as an S-Video signal. To allow the IHS 100 to process the TV broadcast signal, an embodiment provides that the signal is converted from the received analog signal to a digital signal via an analog-to-digital (A/D) converter 144. In another embodiment, the TV broadcast is received as a digital signal and thus bypasses the A/D converter 144.

The digital signal then continues to a video demodulator 146. The video demodulator 146 determines what type of TV signal is received and demodulates it from its broadcast form to a form that is usable by the IHS 100. For example, the video demodulator 146 determines whether the received TV signal is a legacy TV broadcast signal or whether the received TV signal is a high definition (HD) TV broadcast signal and then demodulates it accordingly. After demodulation, a scaler and sample rate converter 148 scales and converts the sample rate of the signal. Next, a noise filter 150 removes noise from the signal. The signal is then processed by an encoder 152, such as a Motion Picture Experts Group (MPEG) encoder. The encoder 152 passes the processed signal to a cache memory device 154, such as a first-in-first-out memory cache. The cache memory device 154 holds the processed signal until a direct memory access (DMA) device 156 can transfer the signal to the HDD 116. In an embodiment, the DMA 156 records the signal to the HDD 116 via an I/O bus 158, such as a PCI bus or a USB bus, and via the memory I/O hub chipset/ south bridge 104. The HDD 116 stores the signal data until it is to be displayed.

When the signal is to be displayed, the playback of the data stored on the HDD 116 is transferred to a soft MPEG decoder 160 for a software decoding. Then, the decoded signal is passed to the graphics processor 110. The decoded signal may be one of several formats. For example, the signal may be a Video Graphics Array (VGA) format 162, a Digital Visual Interface (DVI) format 164, a TVout format 166 or some other format for displaying the video. The VGA format 162 signal may be displayed on a display device 112. The display device may be a cathode ray tube (CRT) or a panel display device. The panel type display device may be a plasma display device, a liquid crystal display (LCD) display device, a Digital Light Processing (DLP) display device or other type of display device. The DVI format 164 signal may be displayed on a panel display device 112. The TVout format 168 may be displayed on a standard TV device 168.

The present disclosure improves upon the TV tuner signal path system 140. For example, the TV tuner signal path system 140 locks in the received TV broadcast signal at the tuner 142 and continues to process that signal until reset. However, the present disclosure provides a system to automatically transition from a single frequency broadcast system (e.g., Digital Video Broadcasting—Handheld (DVB-H), Advanced Television Systems Committee—Mobile/Handheld (ATSC—M/H)) to a multi-frequency broadcast system (e.g., Digital Video Broadcasting—Terrestrial (DVB-T)). Because mobile format TV broadcasting systems generally have lower video quality than stationary format TV broadcasting systems, this allows a user to view improved TV video quality when the IHS 100 is not in motion. On the other hand, the present disclosure also provides for automatically transitioning from a multi-frequency broadcast system to a single-frequency broadcast system to allow the user to continue viewing the TV program while in motion, but in a mobile format. Generally mobile format TV broadcasting systems take into account effects of the receiver being in motion, such as a Doppler effect for the received TV broadcast signals, with respect to the motion of the TV tuner 128. Accordingly, some mobile TV broadcast signals incorporate Doppler shifted information.

In an embodiment, the present disclosure provides a mobile TV receiver 128 capable of both single frequency TV broadcast and multi-frequency TV broadcast reception. In an embodiment, the receiver 128 provides information on current state of motion of the tuner 128 based on Doppler information received in the received mobile TV broadcasts. In an embodiment, the receiver 128 is capable of broadcaster/station identification. This may be performed by decoding identification in the broadcasted TV signals. In an embodiment, the receiver 128 has a database incorporating regional broadcast identifications and assigned frequencies. This identification and frequency data allows the IHS 100 to more accurately determine location, with respect to received TV broadcast signals.

Traditional mobile TV tuners receive mobile TV broadcast Doppler information and discard it. However, the present disclosure contemplates extending traditional TV turner firmware to allow access to the Doppler information that is not typically used for traditional TV player applications, but is available in existing TV broadcast signals.

The present disclosure contemplates context switching between internet protocol (IP) encapsulated video and classic broadcast transport streams. In an embodiment, a broadcaster location database is stored on the HDD 116 or other memory device to map broadcast station identifiers such as those used between single-frequency networks (SFN) and multi-frequency networks (MFN). In an embodiment, this same broadcaster location information may be derived through channel frequency scanning.

In implementation, it is contemplated that the TV tuner signal path system 140 will interact with a mobile database engine 180, a re-tune logic system 182, and a video decoder middleware system 184. The mobile database engine 180 stores data for single-frequency networks (e.g., which may be optimized for mobility) and maps to equivalent multi-frequency networks. In an embodiment, the mobile database engine 180 performs TV station identification look-up using look-up tables (e.g., in Europe and China) and performs geographical frequency scanning (e.g., in U.S.A.). As such, the mobile database engine communicates Doppler information data with the system 140. The re-tune logic system 182 communicates with the mobile database engine 180 and communicates command and control information with the system 140 to cause the tuner 142 to switch from processing a terrestrial TV broadcast signal when the IHS 100 is not in motion (per the Doppler data) to processing a mobile TV broadcast signal when the IHS 100 is in motion (per the Doppler data).

The video decoder middleware system 184 receives the TV broadcast signal from the system 140 as transport stream (TS) data. The middleware 184 processes the TS data and transfers the data to a video decoder 186. The video decoder 186 then decodes the data signal per the applicable data standard, such as MPEG 2, HDMPEG, H264, etc. In an embodiment, the video decoder 186 may up convert the video signal to a near high definition video signal using known methods. Then, the video signal is displayed on the display device 112.

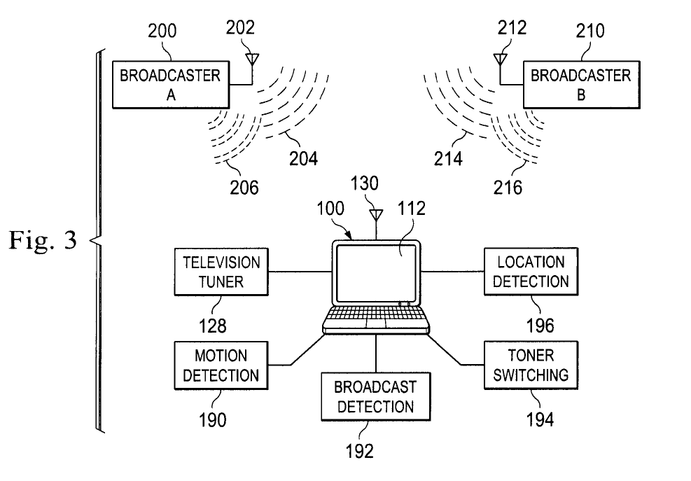

FIG. 3 illustrates a block diagram of an embodiment of an IHS having an optimized mobile television system. It is contemplated that the IHS 100 may be a mobile notebook computing device, a mobile telephone, a gaming device or other electronic device where mobile TV is desired.

FIG. 3 shows broadcaster A 200 broadcasting RF communication signals 204 and 206 using antenna 202. Similarly, broadcaster B 210 is broadcasting RF communication signals 214 and 216 using antenna 212. The broadcast signals 204, 206, 214 and 216 may be any RF broadcast signals. An embodiment provides that the signals 204 and 214 are traditional single frequency TV broadcast signals and the signals 206 and 216 are high definition (HD) multi frequency TV broadcast signals, including coded information, such as station identification and a variety of other information.

The IHS 100 receives the broadcast signals 204, 206, 214 and 216 via the antenna 130. In an embodiment, the IHS 100 is a Dell® Inspiron® mini-series device, however the IHS 100 of the present disclosure may be incorporated into any type of IHS. The antenna 130 may be contained within a shell of the IHS 100 or incorporated into the shell of the IHS 100 and thus, may not be outwardly visible on the IHS 100. Incorporated with the IHS 100 are the TV tuner 128, a motion detection engine 190, a broadcast detection engine 192, a tuner switching engine 194 and a location detection engine 196. It is contemplated that the TV tuner 128, the motion detection engine 190, the broadcast detection engine 192, the tuner switching engine 194 and the location detection engine 196 are configured using a variety of hardware and/or software code for operation. Specific embodiments of the hardware and software may be configured as desired for the specific embodiment of IHS 100.

In operation, the IHS 100 receives the broadcast signals 204, 206, 214 and 216 via the antenna 130 and communicates the received signals to the tuner 128. Applications running on the IHS 100 allow a user to execute a TV watching mode on the IHS 100. In an embodiment, the motion detection engine 190 may include motion sensing components, such as an acceleratometer and/or process Doppler information encoded within the TV broadcast signals to determine whether the IHS 100 is in motion or is stationary. In an embodiment, the motion detection engine 190 may use other means of detecting motion of the IHS, such as a global positioning system (GPS). In an embodiment, the broadcast detection engine 192 reviews the received broadcast signals 204, 206, 214 and 216 and determines broadcast standards of the received broadcast signals 204, 206, 214 and 216, such as standard definition TV, mobile TV, HD TV, and other such standards using information encoded within the broadcast signals 204, 206, 214 and 216. Similarly, the location detection engine 196 may use information coded within the broadcast signals 204, 206, 214 and 216 to determine location of the IHS 100, depending on received signals 204, 206, 214 and 216. In addition, the location detection engine 196 may use other systems for determining location of the IHS, such as a GPS locator device.

In operation, the tuner switching engine 194 incorporates information from the TV tuner 128, the motion detection engine 190, the broadcast detection engine 192 and/or the location detection engine 196 to allow a user to select a TV broadcast program to view and then change back and forth between stationary viewing of the program and mobile viewing of the program, depending on whether the IHS 100 is in motion or not. Two scenarios are provide below to illustrate operation of an embodiment of the present disclosure. However it is contemplated that other scenarios are available within the scope of the present disclosure.

In one scenario, a user is stationary at a location and is watching a TV program on the display 112 of the IHS 100. Because the user is stationary, the IHS displays a higher quality video program, such as one provided by a DVB-T standard. Then, the user leaves the location, and begins traveling, such as traveling in a vehicle. Traditionally, the user would not be able to watch the streaming TV broadcast because of motion Doppler problems in reception, which is well known in the art. However, the IHS 100 of the present disclosure determines that the IHS 100 is in motion and switches reception and processing of the terrestrial broadcast signal to reception, processing and displaying a mobile standard TV broadcast, such as a DVB-H, ATSC-M/H or other standard of the same program. Therefore, the user can continue viewing the same program while stationary and while in motion. In an embodiment, the mobile format signal, such as DVB-H content, will be received in a more mobile-optimized QVGA format with forward error correction which may support mobility in excess of 100 mph, with reduced power and increased battery life for the IHS 100.

To accomplish the above scenario, it is understood that the DVB-T or other stationary broadcast signals (e.g., signals 206 and 216) are typically transmitted on a MFN network where each independent broadcaster (e.g., 200 and 210) is assigned a fixed frequency spectrum allocation within a geographical region. TV in this scenario may be an MPEG transport stream without IP encapsulation. However, these signals may carry additional meta data, like station identifier, program name, time stamps, etc. When the receiver 128 reports Doppler information is above a predefined threshold (may vary by region due to variations in TV modulation formats), the receiver 128 may automatically re tune to the available single frequency network for the region, reinitialize the player application for IP encapsulated video and begin viewing the same program using an approximate program stream based on the MFN station identifier.

In another scenario, a user has transitioned from a moving situation to a more stationary location. In this case, the receiver 128 is no longer utilizing Doppler shifted TV broadcast signal content. Thus, the tuner switching engine 194 may switch tuning to an alternate broadcast format for a higher quality bit stream and thus providing the user with a better quality video image, such as HD TV. In other words, the user may watch higher quality TV when stationary and/or connected to a power source.

To accomplish the second scenario, it is understood that a single frequency network (SFN) uses a broadcast single transport stream that encapsulates multiple IP encapsulated video streams. Each of the program streams may have a unique identifier. For example, this identifier may be a broadcaster name. A multi-frequency network (MFN) has video encapsulated in a transport stream directly broadcast with meta data included to identify the broadcaster. This may be performed in the video blanking interval of the broadcast stream. In an embodiment, the present disclosure maps data extracted from an individual broadcast stream from a SFN with respect to a database lookup table for the given region to identify the target frequency on the MFN. Based on received Doppler information being below a predetermined threshold (this may vary by region due to variations in TV modulation formats), The tuner switching engine 194 may automatically retune the TV receiver 128 from the SFN to the target MFN and re-initialize the TV player application from IP video playback, as used in a SFN, to the broadcast TV format, as used in a MFN. Thus, the IHS may transition from displaying a lower quality mobile video picture (e.g., QVGA) to displaying a higher quality terrestrial video picture (e.g., HD TV).

In summary, an embodiment of the present disclosure provides a system to support an automatic transition from DVB-T to DVB-H (other terrestrial broadcast to mobile broadcast) and vice versa. As such, the present disclosure ensures the same content/channel is continued to be received by the IHS 100, so that the transition between terrestrial and mobile broadcast viewing provides minimal impact to the user's TV watching experience.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A television (TV) receiver system comprising:
a circuit including a TV tuner, the tuner receiving a terrestrial TV broadcast and a mobile TV broadcast;
a motion detection system coupled to the tuner, the motion detection system detecting a motion status of the tuner;
a broadcast detection system coupled to the tuner, the broadcast detection system identifying a source of one of the terrestrial TV broadcast and the mobile TV broadcast; and
a tuner switching system coupled to the tuner, the tuner switching system causing the tuner, as a function of the motion status, to automatically select one of the terrestrial TV broadcast and the mobile TV broadcast for processing.

2. The system of claim 1, wherein the terrestrial TV broadcast is a multi-frequency broadcast.

3. The system of claim 1, wherein the mobile TV broadcast is a single-frequency broadcast.

4. The system of claim 1, wherein the motion status is detected using Doppler information.

5. The system of claim 4, including a location detection system coupled to the tuner, the location detection system detecting a location status of the tuner as a function the source of one of the terrestrial TV broadcast and the mobile TV broadcast.

6. The system of claim 1, wherein the tuner switching system causes the tuner to select the terrestrial TV broadcast for processing when the motion status indicates that the tuner is not in motion.

7. The system of claim 1, wherein the tuner switching system causes the tuner to select the mobile TV broadcast for processing when the motion status indicates that the tuner is in motion.

8. An information handling system (IHS) comprising:
a processor;
a memory coupled to the processor;
a television (TV) receiver system comprising:
a circuit including a TV tuner, the tuner receiving a terrestrial TV broadcast and a mobile TV broadcast;
a motion detection system coupled to the tuner, the motion detection system detecting a motion status of the tuner;
a broadcast detection system coupled to the tuner, the broadcast detection system identifying a source of one of the terrestrial TV broadcast and the mobile TV broadcast; and
a tuner switching system coupled to the tuner, the tuner switching system causing the tuner, as a function of the motion status, to automatically select one of the terrestrial TV broadcast and the mobile TV broadcast for processing; and
a display device coupled to the processor, the display device displaying the selected TV broadcast.

9. The IHS of claim 8, wherein the terrestrial TV broadcast is a multi-frequency broadcast.

10. The IHS of claim 8, wherein the mobile TV broadcast is a single-frequency broadcast.

11. The IHS of claim 8, wherein the motion status is detected using Doppler information.

12. The IHS of claim 11, including a location detection system coupled to the tuner, the location detection system detecting a location status of the tuner as a function the source of one of the terrestrial TV broadcast and the mobile TV broadcast.

13. The IHS of claim 8, wherein the tuner switching system causes the tuner to select the terrestrial TV broadcast for processing when the motion status indicates that the tuner is not in motion.

14. The IHS of claim 8, wherein the tuner switching system causes the tuner to select the mobile TV broadcast for processing when the motion status indicates that the tuner is in motion.

15. A method comprising:
receiving a terrestrial TV broadcast and a mobile TV broadcast using a TV tuner;
detecting a motion status of the tuner;
identifying a source of one of the terrestrial TV broadcast and the mobile TV broadcast;
automatically selecting, as a function of the motion status, one of the terrestrial TV broadcast and the mobile TV broadcast for processing; and
displaying the selected TV broadcast.

16. The method of claim 15, wherein the terrestrial TV broadcast is a multi-frequency broadcast.

17. The method of claim 15, wherein the mobile TV broadcast is a single-frequency broadcast.

18. The method of claim 15, wherein the motion status is detected using Doppler information.

19. The method of claim 18, including detecting a location status of the tuner as a function the source of one of the terrestrial TV broadcast and the mobile TV broadcast.

20. The method of claim 15, including causing the tuner to select the terrestrial TV broadcast for processing when the motion status indicates that the tuner is not in motion and causing the tuner to select the mobile TV broadcast for processing when the motion status indicates that the tuner is in motion.
